(19) United States
(12) Patent Application Publication
(10) Pub. No.: US 2023/0330951 A1
(43) Pub. Date: Oct. 19, 2023

(54) PROCESS OF MOULDING OF A CONTAINER FOR VEHICLE BATTERIES

(71) Applicant: PERSICO S.P.A, NEMBRO (IT)

(72) Inventors: Andrea FUMAGALLI, NEMBRO (IT); Matteo RADI, NEMBRO (IT)

(73) Assignee: PERSICO S.P.A, NEMBRO (IT)

(21) Appl. No.: 18/044,581

(22) PCT Filed: Aug. 16, 2021
(86) PCT No.: PCT/IT2021/050263

§ 371 Date: Mar. 9, 2023

(30) Foreign Application Priority Data
Sep. 15, 2020 (IT) 102020000021787

(51) Int. Cl. B29C 70/46; B29C 70/18

(52) U.S. Cl. CPC B29C 70/46; B29C 70/18; B29L 2031/7146

(57) ABSTRACT

Process of moulding a container (9) for vehicle batteries, comprising providing a mould (10) comprising a first half-mould (11) and a second half-mould (12) each having a respective conformation surface (13); counter-shaping the first layer (1) to the conformation surface (13) of the first half-mould (11); coupling to the first layer (1) a second layer (2) of polymeric material comprising a thermosetting matrix (3) and a reinforcing material dispersed in the matrix; closing the mould (10) with the first (1) and the second layer (2) interposed between the conformation surfaces (13) to simultaneously form the first (1) and the second layer (2); with the mould (10) closed, thermosetting the matrix (3) to make the first (1) and the second layer (2) adhere to each other and to make the container (9).

### TECHNICAL FIELD OF THE INVENTION

The present invention relates to a process of moulding of a container for vehicle batteries, for example for the battery pack of a car.

### PRIOR ART

In the context of the processes of moulding of components for the automotive industry, the document JP2893896B2 describes the moulding of composite panels (i.e. having mainly planar shape) having shielding properties against electromagnetic radiations and comprising a first layer of polymeric material and a second layer of aluminum foil (which confers the electromagnetic shielding properties) adhered to each other. The composite panels thus made are typically used to protect the electrical and/or electronic equipment of the vehicle from electromagnetic fields which can cause disturbances and/or malfunctions.

Typically, the aforesaid polymeric material used comprises a matrix of thermosetting resin and a plurality of glass fibre reinforcing elements dispersed in the matrix. The polymeric material in the raw state (i.e. before the moulding process) is typically at the plastic state and in the form of panels or sheets (in the jargon defined as SMC, from the English “sheet molding compound”).

In the aforementioned moulding, the raw polymeric material is inserted into the mould together with the virgin aluminum sheet, the latter placed directly in contact with the polymeric material. The mould is then closed and heated to thermoset the resin and make the two layers adhere to each other.

### SUMMARY OF THE INVENTION

In the context of the processes of moulding for the production of containers for vehicle batteries (which require electromagnetic shielding), the Applicant has felt the need to mould the whole container, typically having shape of tank (e.g. having a bottom and side walls that develop starting from the bottom substantially perpendicularly to the bottom itself), by means of a process having a single moulding phase (i.e. a single phase in which the final shape is given to the layer of polymeric material and to the layer of metallic material and the aforementioned two layers are firmly adhered together).

In this way it is in fact possible to limit the times and/or the costs for manufacturing the whole container, with respect for example to a process comprising a moulding step for each individual part of substantially planar shape (for example by means of the known process of moulding of composite panels to separately make the bottom and the individual walls) and the subsequent assembly of the parts to make the container. Furthermore, the container obtained by a single process of moulding has better structural strength and/or lightness properties than a container made by assembling substantially planar single parts.

On the contrary, the Applicant has found that the process of moulding of composite panels described in the aforementioned JP2893896B2 is not suitable for making finished products having substantially non-planar shape, such as for example the aforementioned tank shape. In fact, as experimentally observed by the Applicant, when the layer of polymeric material and the virgin aluminum sheet are simultaneously inserted in a mould having a cavity shaped to form a container (e.g. tank) rather than a substantially planar product and the mould is closed, the aluminum sheet is subjected to tearing (regardless of the position of the latter with respect to the layer of polymeric material), with consequent rejection of the made product or lack of electromagnetic shielding.

Without limiting to any theory, the Applicant believes that in such situation the sliding of the layer of polymeric material (e.g. the thermosetting resin) in the plastic state generates a high shear and/or compressive force on the aluminum sheet which generates the aforementioned tearing of the aluminum sheet, in particular at the surface portions of the half-moulds that form the side walls of the container which have a substantially vertical development (i.e. substantially parallel to movement direction of the half-moulds) and edges with small radius of curvature (where the walls meet the bottom of the container).

The Applicant has therefore faced the problem of realizing a container for vehicle batteries in a simple, rapid, economical way, ensuring at the same time the mechanical strength and/or lightness and electromagnetic shielding properties of the container.

According to the Applicant, the above problem is solved by a process of moulding of a container for vehicle batteries according to the attached claims and/or having one or more of the following features.

According to an aspect the invention relates to a process of moulding of a container for vehicle batteries. The process comprises:
providing a mould comprising a first half-mould and a second half-mould, each half-mould having a respective conformation surface mutually facing each other;
coupling a first layer of metallic material to the conformation surface of the first half-mould;
counter-shaping said first layer to the conformation surface of said first half-mould;
subsequently, coupling to said first layer a second layer of polymeric material comprising a thermosetting matrix and a reinforcing material dispersed in said thermosetting matrix;
subsequently, closing said mould by pressing said first and second half-mould one against the other with said first and second layer interposed between said conformation surfaces to simultaneously form said first and second layers;
with said mould closed, thermosetting said matrix of said second layer to make said first and second layer adhere to each other and to make said container.

Without limiting to any theory, the Applicant believes that the step of counter-shaping the sole first layer to the conformation surface of the half-mould, possibly even in rough way, allows arranging the first layer sufficiently close to the half-mould to be able to unload to the half-mould at least part of the compressive stress component acting on the first layer during forming (i.e. when the two half-moulds are pressed against each other), for substantially a whole surface extension of the first layer. In this way, it is globally reduced the total stress to which it is subjected the first layer, which can thus more effectively withstand the combined action of compression and shear due to the sliding of the second layer in plastic form during the forming step, avoiding the aforementioned tearing.

Therefore, by introducing the aforementioned counter-shaping step of the sole first layer, absent in the processes of the known art which, making substantially planar composite panels, directly press the two half-moulds towards each other with the aluminum sheet still virgin (i.e. without any counter-shaping—not even roughly made—to the surface of one of the two half-moulds), it is possible to make the whole container in a process having a single moulding step (which preferably comprises the forming of the two layers and the thermosetting of the matrix).

Furthermore, thanks to the initial counter-shaping of the sole first layer to the first half-mould, that is, on the same half-mould successively used for the forming step, the complexity, and/or duration, and/or costs of the entire process are reduced.

By ‘substantially perpendicular’ with respect to geometric elements (such as straight lines, planes, surfaces etc.) it is meant that these elements form an angle of 90°+/−15°, preferably of 90°+/−10°.

By ‘substantially parallel’ with respect to the aforementioned geometric elements it is meant that these elements form an angle of 0°+/−15°, preferably of 0°+/−10°.

The present invention in one or more of the above aspects may have one or more of the following preferred features.

In one embodiment said process comprises providing a counter-shaping body, distinct from said second half-mould, having a respective conformation surface substantially counter-shaped to, and facing, the conformation surface of said first half-mould. Preferably said counter-shaping said first layer is performed by means of said counter-shaping body. Preferably said counter-shaping comprises reciprocally approaching said first half-mould and said counter-shaping body to press said first layer between the respective conformation surfaces of said first half-mould and counter-shaping body.

Typically, the counter-shaping body has smaller dimensions and/or weight than the second half-mould and/or it does not require the systems and the thrusts typical of the second half-mould to be handled, as it does not have to exert high pressures to form the finished product but only give the preliminary shaping to the first layer. Furthermore, the counter-shaping body does not require heating systems to heat the first layer.

For example, the counter-shaping body can be mounted directly on a robotic arm which couples the first layer to the conformation surface of the first half-mould.

In this way, the counter-shaping is performed quickly and easily.

In one embodiment, said counter-shaping of said first layer is performed by means of said second half-mould. In this way, no further movable elements (and any respective handling systems) are provided.

Preferably said counter-shaping comprises reciprocally approaching said first and second half-mould to press said first layer between the respective conformation surfaces of said first and second half-mould. Preferably said process comprises, before said coupling said second layer, mutually moving said first and second half-mould away from each other.

Preferably said process comprises, at least after said closing said mould and more preferably during said thermosetting said matrix, applying a depression in a moulding cavity of said mould defined by said conformation surfaces of the first and of the second half-mould (when the mould is closed). In this way it is reduced and/or avoided the creation of bubbles due to the gases released as a result of the thermosetting process of the matrix, which could lead to defects on the finished product, such as for example malformations and/or lack of and/or poor adhesion between the first and second layer.

By the expression “applying a depression” it is meant establishing a pressure lower than the atmospheric pressure inside the cavity, typically by sucking air from the moulding cavity (i.e. making vacuum).

Preferably said metallic material is aluminum or an aluminum alloy (which is light and at the same time strong). Preferably a thickness of said first layer before said counter-shaping is greater than or equal to 0.05 mm, and/or less than or equal to 0.5 mm.

Preferably said first layer comprises a plurality of through holes, more preferably arranged according to a regular pattern and uniformly distributed over a whole surface extension thereof. The holes facilitate the elimination of the aforementioned bubbles due to the gases that are generated between the first and second layer. Furthermore, the Applicant has found that the presence of the holes facilitates the adhesion between the first and the second layer, since the matrix of the latter, when still in the plastic state, penetrates into the holes (partially or completely, even to spread on an opposite face of the first layer) and then harden inside these ones during the thermosetting and thus creating a joint between the two layers.

The size and the density of the holes is determined according to the electromagnetic band to be shielded.

Preferably said first layer, before said counter-shaping, is a flat sheet.

Preferably said first layer, before said counter-shaping, has an embossing. For example, said first layer, before said counter-shaping, derives from a flat sheet which has undergone a punching in order to create reliefs (and recesses on the opposite side), typically with shape of rhombus, lozenge or ellipse. Typically, said reliefs are arranged according to a regular pattern and uniformly distributed over a whole surface extension of the flat sheet. Preferably a ratio between embossed surface and not-embossed surface is greater than 50%. In this way, the phases of counter-shaping of the first layer and/or of subsequent forming are facilitated. In fact, the embossing, thanks to the presence of the reliefs, allows to adapt more easily to the conformation surface of the half-mould, reducing the risk of excessive strictions and/or breakages of the first layer.

In one embodiment it is provided arranging, preferably before said counter-shaping, an adhesive layer onto a face of said first layer facing towards said second layer after said coupling said second layer, said adhesive layer being preferably a heat sensitive adhesive (i.e. which is activated when subjected to heat). In this way the adhesion between the two layers is enhanced during the thermosetting of the matrix.

Preferably said matrix is made of polymeric synthetic resin, more preferably selected from the following: polyester resin, vinyl ester resin, epoxy resin.

Preferably said reinforcing material is one of the following: glass fibre, carbon fibre, Kevlar.

Preferably said coupling said second layer comprises distributing an overall mass of said second layer as a function of a geometry of said container. In this way the container having the desired final thickness is produced.

Preferably said second layer before said thermosetting (for example when coupled to said first layer) comprises one or more SMC sheets superimposed on each other substantially along a direction of movement of said half-moulds. In this way it is easy to insert and distribute it into the mould.

In one embodiment said second layer before said thermosetting (for example when coupled to said first layer) comprises one or more blocks of BMC (from the English “bulk moulding compound”). Unlike the SMC, raw BMC comes in the form of a paste without a predetermined shape.

### BRIEF DESCRIPTION OF THE FIGURES

FIGS. 1-4 show in a purely schematic way some exemplary steps of a process of moulding according to the present invention;

FIG. 5 shows in a purely schematic way a container for batteries obtained by the process of FIGS. 1-4.

### DETAILED DESCRIPTION

The features and the advantages of the present invention will be further clarified by the following detailed description of some embodiments, presented by way of non-limiting example of the present invention, with reference to the attached figures.

With reference to FIG. 5, the number 9 globally indicates a container for batteries (not shown) of a vehicle (not shown) obtainable by means of the process of moulding of the present invention.

Exemplarily the container 9 comprises a first portion 91 made starting from a first layer 1 of metallic material (e.g. aluminum) and a second portion 92 made starting from a second layer 2 of polymeric material comprising, before performing the process of moulding (in particular at least before the thermosetting step described below), a thermosetting matrix 3 and a reinforcing material (exemplarily shown in a purely schematic way by means of dashes) dispersed in the matrix 3. Exemplarily the matrix 3 is made of a synthetic polymeric resin selected among the following: polyester resin, vinyl ester resin, epoxy resin, and the reinforcing material is one of the following: glass fibre, carbon fibre, Kevlar.

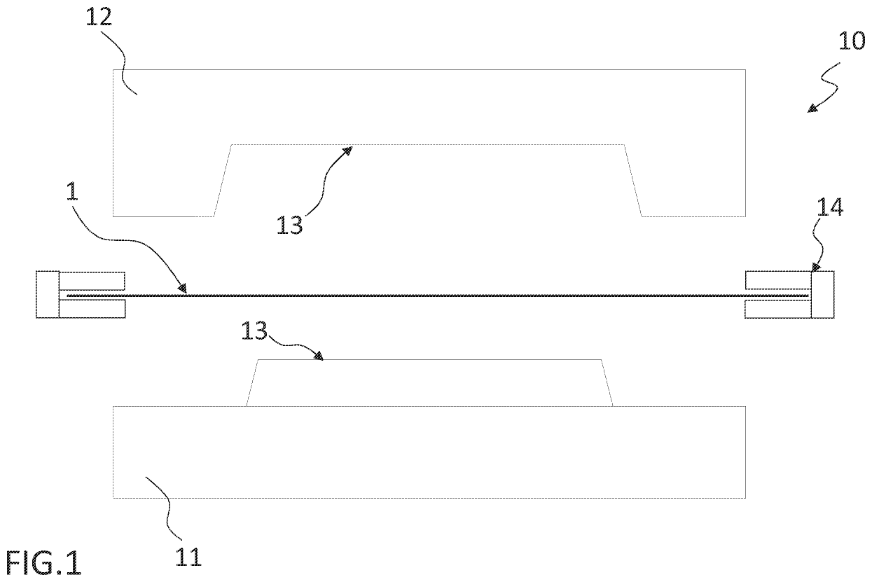

In the following it is described a process of moulding according to the present invention, with reference to FIGS. 1-4 which show in a purely schematic way some sections of the elements used in the process.

First of all, the process of moulding exemplarily comprises providing a mould 10 comprising a first half-mould 11 and a second half-mould 12, each half-mould 11, 12 having a respective conformation surface 13 mutually facing each other. Exemplarily, the first half-mould 11 is inferiorly arranged and it has the conformation surface which comprises a protruding portion, and the second half-mould 12 is superiorly arranged and it has the conformation surface which comprises a concave portion. The present invention also contemplates further embodiments (not shown) in which the first half-mould can be the one whose conformation surface comprises the concave portion and/or which can be superiorly arranged.

Exemplarily it is therefore provided coupling the first layer 1 of metallic material to the conformation surface 13 of the first half-mould 11. Exemplarily (not shown) the first layer 1 comprises a plurality of through holes, arranged according to a regular pattern and uniformly distributed over a whole surface extension thereof.

Exemplarily in FIG. 1 it is shown in a purely schematic way a handling system 14 comprising a pair of grippers for arranging the first layer 1 between the first and the second half-mould. Optionally, the handling system 14 can be mounted on a multi-axis robotic arm (not shown).

In one alternative embodiment, the first layer can be coupled to the first half-mould before the second half-mould is arranged in line (e.g. superiorly) with the first half-mould (for the subsequent closing).

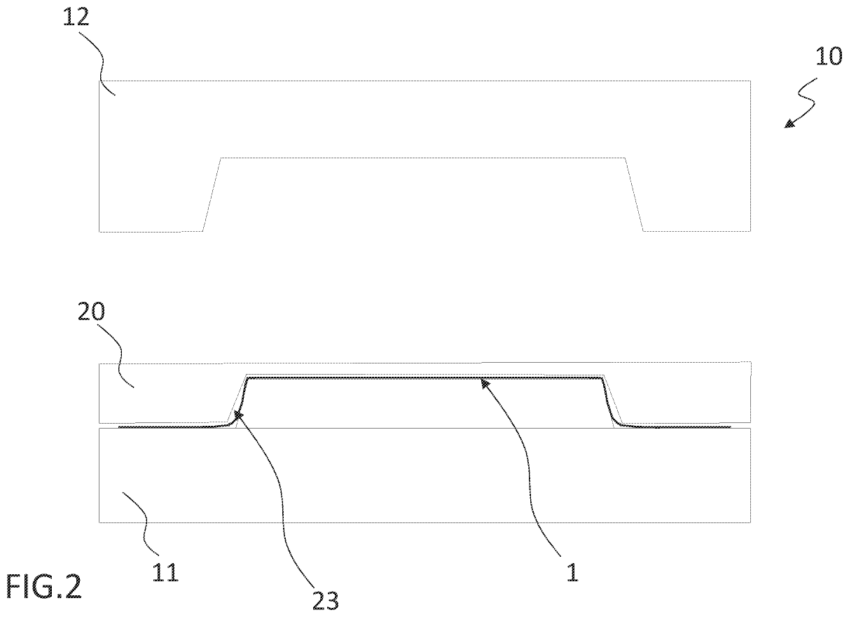

Exemplarily (FIG. 2) it is subsequently provided counter-shaping the first layer 1 to the conformation surface 13 of the first half-mould 11. Exemplarily the counter-shaping is performed in rough way (as schematically shown by the fact that the first layer does not perfectly follow the conformation surface of the first half-mould). The Applicant has in fact experimentally observed that even a rough counter-shaping of the first layer to the conformation surface of the half-mould is sufficient to arrange the first layer sufficiently close to the first half-mould to unload to the half-mould at least a part of the compressive stress component (typically locally directed substantially perpendicularly to the surface of the first layer, and therefore of the first half-mould) acting on the first layer during the forming in order to prevent tearing, without at the same time lengthening and/or excessively complicating the process of moulding.

Exemplarily (FIG. 1), before the aforementioned counter-shaping step, the first layer 1 is a flat sheet having a thickness of about 0.2 mm.

Exemplarily the first layer 1, before the aforementioned counter-shaping step, has an embossing (not shown), having a ratio between embossed surface and not-embossed surface greater than about 50%.

In one embodiment (not shown) it is provided arranging, preferably before counter-shaping the first layer, an adhesive layer onto a face of the first layer facing the second layer after the coupling step of the second layer to the first layer (described below), the adhesive layer being preferably a heat-sensitive adhesive to be activated only during the thermosetting step (described below).

Exemplarily (FIG. 2), the process comprises providing a counter-shaping body 20, distinct from the second half-mould 12, having a respective conformation surface 23 substantially counter-shaped to, and facing towards, the conforming surface 13 of the first half-mould 11 (exemplarily having therefore a concave portion).

Exemplarily counter-shaping the first layer 1 is performed by means of the counter-shaping body 20 and comprises reciprocally approaching the first half-mould 11 and the counter-shaping body 20 to press the first layer 1 between the respective conformation surfaces 13, 23 (FIG. 2 shows the substantially final phase of the counter-shaping of the first layer 1).

Optionally (not shown) the counter-shaping body 20 can be mounted directly on the same robotic arm that couples the first layer to the conformation surface of the first half-mould, i.e. on the robotic arm wherein the aforementioned handling system 14 can be mounted.

In one embodiment (not shown) counter-shaping the first layer 1 is performed by means of the second half-mould 12 and it comprises reciprocally approaching the first 11 and the second half-mould 12 to press the first layer 1 between the respective conformation surfaces 13. Preferably the process comprises, before coupling the second layer 2 (as described below), move the first and second half-mold away from each other.

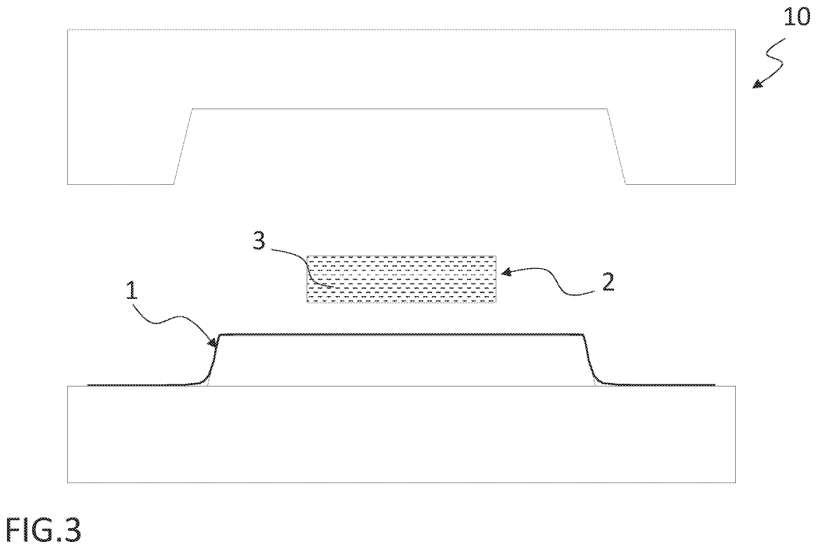

Subsequently (FIG. 3), it is exemplarily provided coupling to the first layer 1 the second layer 2 of polymeric material. For example, the second layer can comprise one or more SMC sheets (not shown) substantially superimposed on each other along a direction of movement of the half-moulds (exemplarily vertical lying on the plane of the figures) which are laid on the first counter-shaped layer. Optionally (not shown) coupling the second layer 2 comprises distributing an overall mass of the second layer as a function of a geometry of the container, for example distributing a number of the aforementioned one or more SMC sheets.

In one embodiment (not shown) the second layer before the thermosetting step (for example when coupled to the first layer) can comprise one or more blocks of BMC, i.e. a paste without a predetermined shape.

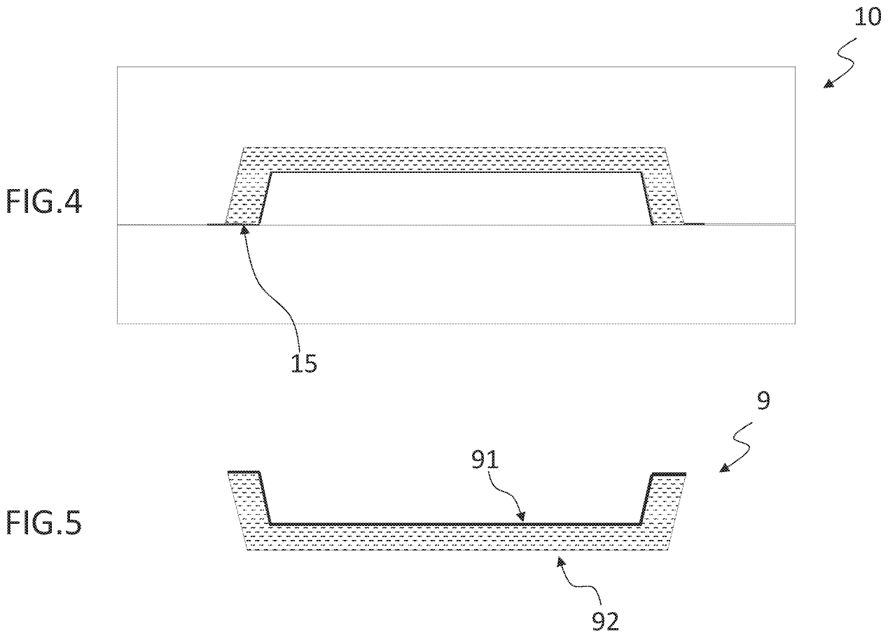

Subsequently (FIG. 4), it is exemplarily provided closing the mould 10 by pressing the first 11 and the second half-mould 12 one against the other with the first 1 and second layer 2 interposed between the conformation surfaces 13 to simultaneously form the first 1 and the second layer 2.

Exemplarily it is therefore provided, with the mould 10 closed, thermosetting the matrix 3 of the second layer 2 to make the first 1 and the second layer 2 adhere to each other and to make the container 9.

Exemplarily the thermosetting of the matrix is performed by heating one or both of the two half-moulds.

Exemplarily the process comprises, at least after closing the mould 10 and during the thermosetting the matrix, applying a depression in a moulding cavity 15 of the mould 10 defined by the conformation surfaces 13 of the first and second half-mould when the mould is closed. For example, the depression (with respect to the atmospheric pressure) is established by suction of air from the moulding cavity by means of a plurality of ducts (not shown) made in one or both of the half-moulds and connected to a suction circuit (not shown).

Finally, it is exemplarily provided opening the mould and removing the finished product to obtain the container 9 as shown in FIG. 5. Optionally (not shown) the container (before and/or after being removed from the mould) can be subjected to finishing operations, for example smoothing and/or cutting of any protruding portions of the first and/or of the second layer, to adapt it to the manufacturing standards.

What is claimed is:

1. A process for moulding a container for vehicle batteries, the process comprising:
providing a mould comprising a first half-mould and a second half-mould, each half-mould having a respective conformation surface mutually facing each other;
coupling a first layer of metallic material to the conformation surface of the first half-mould;
counter-shaping the first layer to the conformation surface of the first half-mould;
subsequently, coupling to the first layer a second layer of polymeric material comprising a thermosetting matrix and a reinforcing material dispersed in the thermosetting matrix;
subsequently, closing the mould by pressing the first and second half-mould one against the other with the first and second layer interposed between the conformation surfaces to simultaneously form the first and second layer;
with the mould closed, thermosetting the matrix of the second layer to make the first and second layer adhere to each other and to make the container.

2. The process according to claim 1, comprising providing a counter-shaping body, distinct from the second half-mould, having a respective conformation surface substantially counter-shaped to, and facing, the conformation surface of the first half-mould, wherein the counter-shaping the first layer is performed by means of the counter-shaping body and it comprises reciprocally approaching the first half-mould and the counter-shaping body to press the first layer between the respective conformation surfaces of the first half-mould and counter-shaping body.

3. The process according to claim 1, wherein the counter-shaping the first layer is performed by means of the second half-mould and it comprises reciprocally approaching the first and second half-mould to press the first layer between the respective conformation surfaces of the first and second half-mould, and wherein the process comprises, before the coupling the second layer, mutually moving the first and second half-mould away from each other.

4. The process according to claim 1, comprising, at least after the closing the mould and preferably during the thermosetting the matrix, applying a depression in a moulding cavity of the mould defined by the conformation surfaces of the first and of the second half-mould.

5. The process according to claim 1, wherein the metallic material is aluminum or an aluminum alloy, wherein a thickness of the first layer before the counter-shaping is greater than or equal to 0.05 mm, and/or less or equal to 0.5 mm, and wherein the first layer comprises a plurality of through holes, preferably arranged according to a regular pattern and uniformly distributed over a whole surface extension of the first layer.

6. The process according to claim 1, wherein the first layer, before the counter-shaping, is a flat sheet, and wherein the first layer, before the counter-shaping, has an embossing, and wherein a ratio between embossed surface and not-embossed surface is greater than 50%.

7. The process according to claim 1, wherein it is provided arranging an adhesive layer onto a face of the first layer facing towards the second layer after the coupling the second layer.

8. The process according to claim 1, wherein the matrix is made of polymeric synthetic resin, selected from the following: polyester resin, vinyl ester resin, epoxy resin, and wherein the reinforcing material is selected from the following group: glass fibre, carbon fibre, Kevlar.

9. The process according to claim 1, wherein the coupling the second layer comprises distributing an overall mass of the second layer as a function of a geometry of the container.

10. The process according to claim 1, wherein the second layer before the thermosetting comprises one or more SMC sheets superimposed on each other substantially along a direction of movement of the half-moulds.

11. The process according to claim 1, wherein the second layer before the thermosetting, comprises one or more blocks of BMC.
